(19) United States
(12) Patent Application Publication
(10) Pub. No.: US 2023/0274364 A1
(43) Pub. Date: Aug. 31, 2023

(54) SYSTEM OF DYNAMICAL LINKAGES TO APPRAISE FINACIAL INSTRUMENTS

(71) Applicant: Victor Hugo Martinez, Croton on Hudson, NY (US)

(72) Inventor: Victor Hugo Martinez, Croton on Hudson, NY (US)

(21) Appl. No.: 18/144,768

(22) Filed: May 8, 2023

Related U.S. Application Data
(63) Continuation-in-part of application No. 17/523,090, filed on Nov. 10, 2021.

(51) Int. Cl. G06Q 40/06

(52) U.S. Cl. CPC G06Q 40/06

(57) ABSTRACT

The present invention provides a system for appraisal of financial instruments, comprising an input device and a computer server with at least one financial fund database. The fund database and sub-funds are dynamically linked to their holdings, assets, and asset values at specific times. The holdings to assets links and assets to asset values links at specific times are separated. A graphical interphase represents the links. The server obtains asset values by means of the internet of things. One asset value corresponds to one specific time. The server updates holdings changes and asset value changes. The server adds new links when the fund acquires a new sub-fund, new holdings and new asset values. The server updates asset values, holdings, and new links corresponding to the new holdings, new asset and new asset values at specific times. Appraisals are derived from queries traversing the linked structures automatically following specific time values.

### CROSS-REFERENCE AND PRIORITY CLAIM TO RELATED PATENT APPLICATION

This patent application is a continuation in part of U.S. patent application Ser. No. 17/523,090 filed Nov. 10, 2021 and entitled “Dynamical Linkages for Appraisal of Financial Instruments”, to which it claims priority in part.

### BACKGROUND OF THE INVENTION

### 1. Field of the Invention

The present invention is related to a system comprising a method for appraisal of financial instruments, e.g., funds, wherein the system comprises at least one input device, a computer server with at least one financial instrument database or fund database, wherein the fund database comprises sub-funds, where the fund and sub-fund are linked hierarchically, wherein the fund and sub-funds are linked to their holdings, wherein the holdings are linked their assets independently, and wherein the assets are linked separately to their asset values at specific times.

### 2. Description of Prior Art

Historically, appraisal of financial instruments are based on relational databases of structurally rigid related tables, wherein each table correspond to a fund, an asset, specific times, etc., wherein appraisals are obtained by joining the tables using computed automated methods or even manual methods, wherein the tables have redundant and repeated information making the appraisal process inefficient and cumbersome.

The present invention provides a system comprising a method to appraise financial instruments, wherein the static values for financial assets are not repeated, wherein all the dynamic variables related to those static values are linked in a graphical interphase, and wherein the appraisal of the financial instrument is made with a one instance traversal query or swipe without the need of tables.

### SUMMARY OF THE INVENTION

The present invention provides a system comprising a method for appraisal of financial instruments, wherein the system comprises an input device, a computer server with at least one financial instrument database, e.g., a fund database, wherein the fund database comprises sub-funds of the fund dynamically linked to their holdings, their assets, and their asset values at a specific times, wherein the links of holdings to the assets and the links of the assets to their asset values at specific times are separated, wherein the dynamic links are represented by a graphical interphase, wherein the computer server make dynamic queries by means of the internet of things (Iot) of the asset values, wherein there is only one asset values at one same specific time, wherein at each time there is a change in the holdings and in the asset values the computer server makes an update, wherein the computer server updates the database by adding new link structures when the fund acquires, a new sub-fund, a new holding and a new asset value, where the computer server make the updates of the asset values and the holding, and the new links corresponding to the new holdings new asset and new asset values at specific times, wherein the dynamic or real time appraisal of the fund is derived from queries traversing the existing following the same time values of the linked structures automatically generating appraisals for those specific time values.

Specifically, the present invention provides a system to appraise a fund comprising:
a. At least one input device;
b. at least one computer server, wherein the input device connects with the computer server, wherein the computer server contains the fund database, wherein the fund database comprises sub-funds of the fund, wherein the fund and each sub-fund are connected hierarchically by links, wherein the fund and each sub-fund are linked to theirs holdings, wherein the holdings for each sub-fund are linked to their assets, wherein the assets are linked to their asset values at specific times, wherein the links of the holdings to their assets and the links of the assets to the asset values are separated, wherein the dynamic appraisal of the fund is derived from traversal queries following the time specific values of the linked structures, wherein the links of the database are represented by a graphical interphase;
   wherein an user by means of the input device makes queries to the computer server, wherein the computer server is programmed to dynamically make traversal queries of new asset values at specific times by means of the internet of things, wherein the computer server is programmed to appraise the fund without repeating the static information for an asset, wherein the computer server updates the appraisal of the fund by adding new holdings, new assets and new asset values, wherein the computer server updates the appraisal of the fund each time a holding changes, and wherein the computer server updates each time an asset value changes.

In one aspect of the system of the present invention the computer server updates the appraisal of the fund by creating for each event of a new holding a linked structure, wherein the new linked structure is created at a specific time, wherein the appraisal is derived from the traversal query following the times values of the linked structures.

In another aspect of the system of the present invention the computer server updates the appraisal of the fund by creating for each event of a new asset value change a new link, wherein the new link is created in a specific time, wherein the appraisal is derived from the traversal query following the times values of the linked structures.

Objectives and advantages of the present Application invention will be more evident in the detailed description of the invention and the claims.

### BRIEF DESCRIPTION OF THE DRAWINGS

FIG. 1. is an illustration showing the hierarchical structure where a sub-fund is linked to its holdings at specific times, wherein the holding dynamic values are linked to a single node with the static information of the holdings' asset, and wherein each node with an asset's static information are linked to the times values for the each asset.

FIG. 2. is an illustration showing the hierarchical structure of a sub-fund and wherein a second sub-fund is added with a holding with a common asset. The hierarchical structure for the holding with the common asset has a link the already existing node with the static information for the common asset

FIG. 3. is an illustration showing the full structure of a database wherein there are nodes for partial sub-funds.

FIG. 4. Is an illustration showing two parallel appraisal traversal queries (13) following two time values, wherein the traversal queries are represented by double arrow lines, wherein in this embodiment of the invention the two time values are T1 and T2.

FIG. 5. is an illustration of a hierarchical structure of the method of the present invention, wherein a sub-fund for have two additional levels of the hierarchy represent the time values for a contract's holdings, and a single node with static information for the derivatives contract.

FIG. 6. is an illustration showing a representation of the computer server (1) of the present invention, wherein the computer server with a database (2) made external queries, represented by a dotted double ended arrow line (3), of asset values by means of the internet of things, and updates internally from entries, represented by a dotted one end arrow line (4), of changes in at least one holding's information.

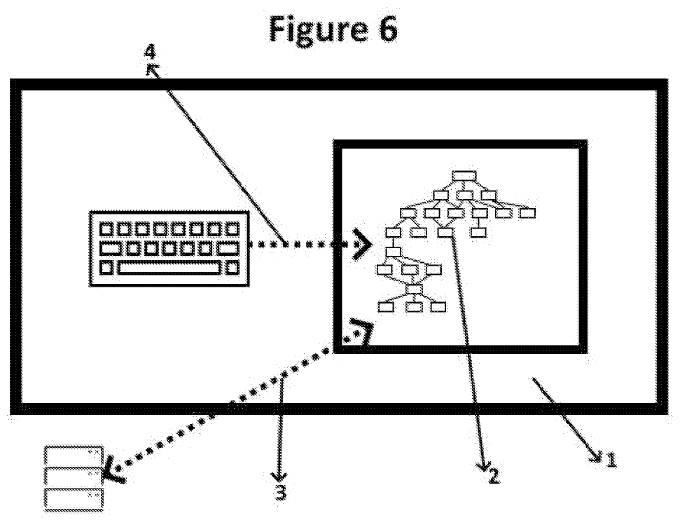

FIG. 7. is an illustration showing the system of the present invention wherein the input device (14) connects with the server.

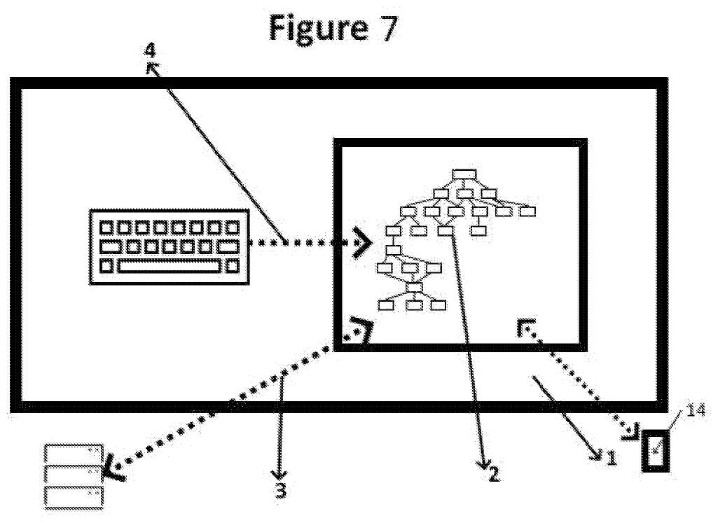

### DETAILED DESCRIPTION OF THE INVENTION

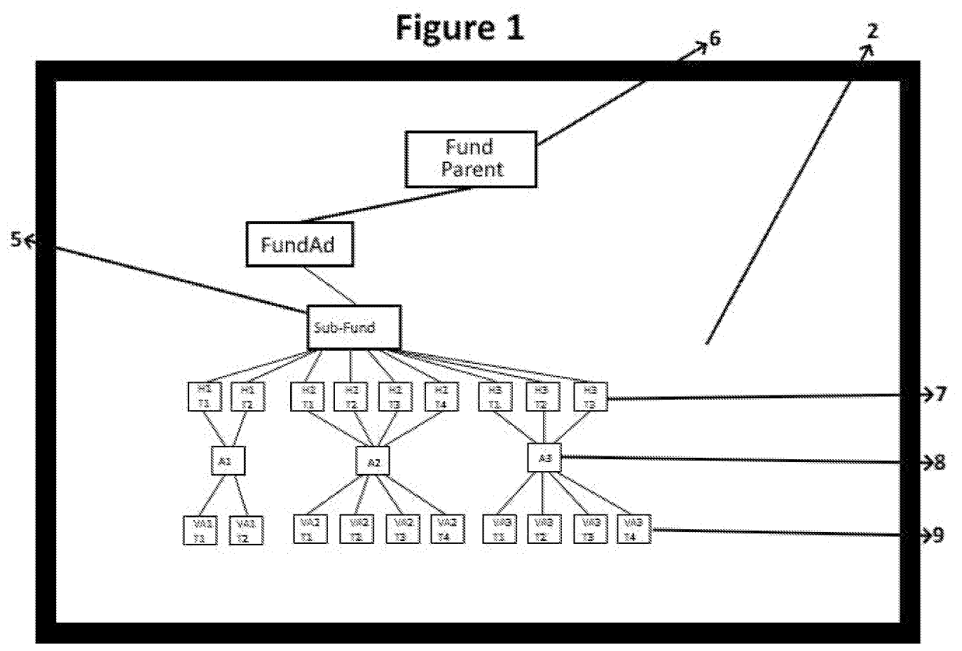

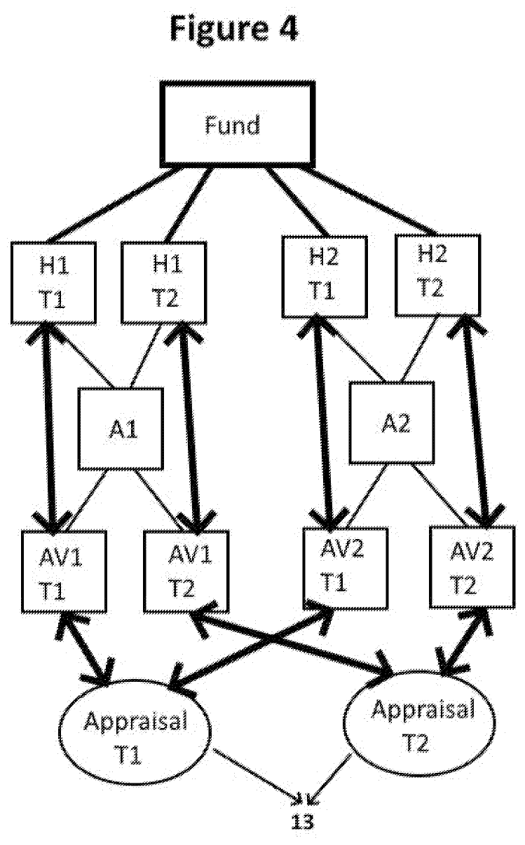

FIG. 1 shows an illustration of an embodiment of a system comprising a method to appraise a fund comprising:
a. At least one input device (14);
b. at least one computer server (1), wherein the input device (14) connects with the computer server, wherein the computer server wherein the computer server (1) contains the fund database (2), wherein the fund database (2) comprises sub-funds (5) of the fund (6), wherein the fund (6) and each sub-fund (5) are connected hierarchically by links, wherein the fund and each sub-fund are linked to theirs holdings (7), wherein the holdings (7) for each sub-fund (5) are linked to their assets (8), wherein the assets are linked to their asset values (9) at specific times, wherein the links of the holdings (7) to their assets (8) and the links of the assets (8) to the asset values (9) are separated, wherein the dynamic appraisal of the fund (6) is derived from traversal queries (FIG. 4) following the time specific values of the linked structures, wherein the links of the database are represented by a graphical interphase;

Wherein an user by means of the input device (14) makes queries to the computer server (1), wherein the computer server (1) is programmed to dynamically make traversal queries (3) of new asset values (9) at specific times by means of the internet of things, wherein the computer servers (1) is programmed to appraise the fund (6) without repeating the static information for an asset (8), wherein the computer server (1) updates the appraisal of the fund (1) by adding new holdings, new assets and new asset values, wherein the computer server updates the appraisal of the fund each time a holding changes, and wherein the computer server updates each time an asset value changes.

For the purpose of the present invention the term “input device” (14) refers to:
a smart phone;
a keyboard,
a device programmed to receive voice commands,
any other device able to connect to a computer server, wherein the device can be commanded to rely queries and/or commands to the server from a user.

In one aspect of the system of the present invention the computer server (1) updates the appraisal of the fund by creating for each event of a new holding a linked structure, wherein the new linked structure is created at a specific time, wherein the appraisal is derived from the traversal query following the times values of the linked structures (FIG. 4).

In another aspect of the system of the present invention the computer server (1) updates the appraisal of the fund (6) by creating for each event of a new asset value change a new link, wherein the new link is created in a specific time, wherein the appraisal is derived from the traversal query following the times values of the linked structures (FIG. 4).

For the purpose of the present invention a holding in the database is stored as a node (7), wherein the node for a holding (7) is decoupled from its assets (8) with links, wherein each asset (8) will be stored in the database (2) independently from the node for the holding (7) as one another node with the asset's static information (8), and the asset values (9) over time that denotes the dynamic information for the asset, are stored in the database (2) also independently as nodes with the asset values (9) at specific times, wherein the one node with the asset's basic static information (8) will have a link to each node with a time specific asset value (9). Therefore, the database (2) can only have one node for the asset's static basic information (8) which is decoupled by links to the nodes that store specific time asset values (9). Traversing the information following the links for a specific time will result in the appraisal (FIG. 4) of the fund at that specific time. A fund value can be retrieved using, for example, a Gremmlin® standard query in a graphical database. The terms asset's static information refers to the asset's name, id, etc.

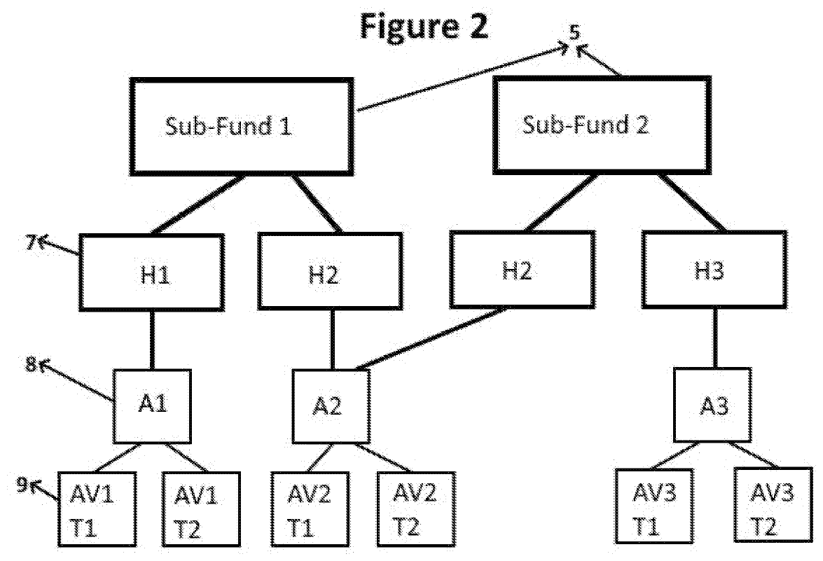

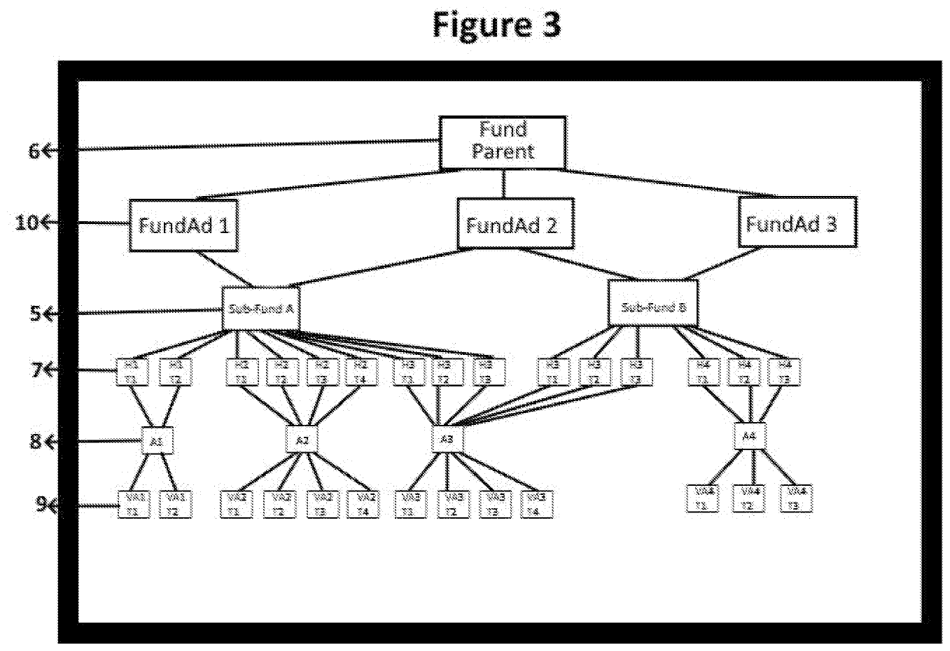

The present invention avoids redundancy (FIGS. 2, 3) and resulting errors in the database (2) by not repeating an asset's static information (8), and not repeating a specific time asset value, wherein a node with an asset's static information (8) and the node for its time specific asset value or nodes for its time specific asset values (9) can be linked to all the database's holdings (7) that contain such asset (8), even if those holdings are spread between or among different sub-funds. This graphical database structure allows an instant or real time appraisal, e.g., by using a Gremmlin® standard query of the fund.

Another advantage of the system of the present invention is the appraisal of partial funds within the fund. As shown in FIG. 3 the Parent fund is splitted into three partial funds, FundAd 1, FundAd 2 and FundAd 3 (FIG. 3, 10), wherein FundAd 1 is only linked to Sub-Fund A and Sub-Fund A's hierarchically linked holdings. Sub-Fund A is subsequently linked to holdings H, H2 and H3 (5) at specific times which indicate that these holdings have dynamically changed at specific times with respect to respective assets A1, A2, and A3 (8), wherein the A1, A2 and A3 are static, while their asset values VA1, VA2, and VA3 (9), to which these holdings are linked, also change dinamically at specific times. The appraisal for Partial FundAd 1 and the dynamics of only its Sub-fund A and Sub-Fund A's holdings, assets, and asset values is particularly useful in keeping accounting records or performance of only Sub-Fund A.

In an additional aspect of the system of the present invention, the database is structured in such a way that the query to obtain the appraisal of the fund can be made with a traversal or swipe that in a single instant visit all of the nodes specific for a time value, and if a time series of appraisals are needed, the query to do so comprises a one instant parallelized traversals or swipes that encompasses all the multiple individual parallel queries for specific time value series (FIG. 4), wherein each individual query corresponds to a specific time. In other words, the method of the present invention provides s structure that allows a single instant query to appraise the fund at a single time value, or a time series of appraisals. The products of the queries to appraise the fund will automatically be stored in the placeholders of the database (FIG. 4, 13). This innovative structure will make getting the time series of values of a fund or collection of funds for any place in the hierarchical structure to have the same performance as the calculation of a single time value. Analysis of the fund performance is significantly enhanced due to the immediacy in finding time series values of any collection of assets or financial instruments.

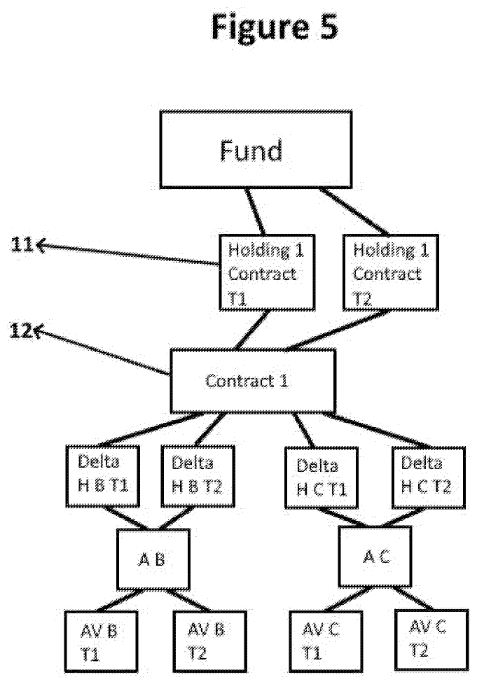

Another aspect of the system of the present invention is the use of method for the management of derivatives. For the purpose of the present invention derivatives are financial contracts (FIG. 5, 12) that derived value from another financial instrument, e.g., an underlying asset. In general, derivatives represent complex relations that change every time the underlying asset changes. If derivative contracts are properly priced, their value will not give rise to profits if the contract is dynamically hedged to eliminate the risk of the underlying changes in prices. This implies that the value of a derivative contract (12) inherently assumes the existence of a portfolio or fund where its components are the derivative contract and the underlying asset with holdings such that the risk or variation due underlying prices changes are eliminated. For the purpose of another embodiment of the method of present invention, the holdings constantly and dynamically change to eliminate the risk. This implies that option contract is equivalent to a portfolio or fund of the underlying asset and a risk free asset or bond for which holdings are constantly changing, wherein there is a node for the contract static information (12) decoupled from the nodes representing its holdings (11) of the contract that are time specific according to the expiration of the contract. Subsequently the node with the contract's static information (12) is decoupled but linked to the holdings with the bonds or underlying assets at specific times, wherein the node with the time specific information for the holding are subsequently decoupled but linked to the node with the static information for each bond or underlying asset, and wherein the node with the static information for the bond or underlying asset is further decoupled but linked to the nodes for the bond or underlying asset values at specific times.

The use of the system of the present invention to derivatives has the same effect of avoiding redundancy since there is only one node for the static information for each contract (12) and each asset. The method of the present invention will also provide all the benefits already described when used for a portfolio or fund comprising derivatives.

For the purposed of the system of the present invention the term financial instrument comprises but are not limited to fund, derivative, portfolio, feeder funds, hedge fund, sleeve, composite, parent fund, master fund, financial contracts, etc. Although the embodiment referred herein mostly refers to funds, it may also be applied to any other financial instrument.

For the purposed of the system of the present invention the term holding refers to the amount of unit that a fund has of an specific asset.

For the purposed of the system of the present invention the term “static information” refers to information that qualitatively describes an asset or a contract, wherein the static information does not change throughout time.

For the purposed of the system of the present invention the term asset refers but is not limited to stocks, currencies, fix income, bonds, commodities, units of real state, etc, wherein the asset value may change throughout time.

For the purpose of the system of the present invention, sub-fund refers but is not limited to any part of a financial instrument that by itself comprises holdings and the holding's assets.

The system of the present invention gives an user, as technological advantage, the ability to obtain instant appraisals for any specific point in time of a financial instrument, e.g., a fund, a portfolio, a derivative, by means of an input device, wherein the input device relay the user's queries and commands to the server, and wherein the server returns the appraisal for the requested point in time of the financial instrument. The computer server determines the appraisal by means of a traversal query that in a single instant visit all the specific nodes for a time value. The returned appraisal may be reviewed in an interphase in the input device or in any kind of screen connected to the server.

Although this description presents preferred embodiments of the present invention, additional changes may be made in the form and disposition of the parts without deviating from the ideas and basic principles encompassed by the claims.

1. A system to appraise a fund comprising:
a. At least one input device;
b. at least one computer server, wherein the input device connects with the computer server, wherein the computer server contains the fund database, wherein the fund database comprises sub-funds of the fund, wherein the fund and each sub-fund are connected hierarchically by links, wherein the fund and each sub-fund are linked to theirs holdings, wherein the holdings for each sub-fund are linked to their assets, wherein the assets are linked to their asset values at specific times, wherein the links of the holdings to their assets and the links of the assets to the asset values are separated, wherein the dynamic appraisal of the fund is derived from traversal queries following the time specific values of the linked structures, wherein the links of the database are represented by a graphical interphase;
wherein an user by means of the input device makes queries to the computer server, wherein the computer server is programmed to dynamically make traversal queries of new asset values at specific times by means of the internet of things, wherein the computer server is programmed to appraise the fund without repeating the static information for an asset, wherein the computer server updates the appraisal of the fund by adding new holdings, new assets and new asset values, wherein the computer server updates the appraisal of the fund by creating for each event of a new holding a linked structure, wherein the new linked structure is created at a specific time, wherein the computer server updates the appraisal of the fund each time a holding changes, and wherein the computer server updates each time an asset value changes.

2. The system of claim 1, wherein the computer server updates the appraisal of the fund by creating for each event of a new holding a linked structure, wherein the new linked structure is created at a specific time, wherein the appraisal is derived from the traversal query following the times values of the linked structures.
